(19) United States
(12) Patent Application Publication
(10) Pub. No.: US 2021/0006045 A1
(43) Pub. Date: Jan. 7, 2021

(54) METHOD FOR MANUFACTURING SPARK PLUG

(71) Applicant: NGK SPARK PLUG CO., LTD., Nagoya-shi (JP)

(72) Inventors: Norihito YABUUCHI, Nagoya-shi (JP); Shinya NAKAMURA, Nagoya-shi (JP)

(73) Assignee: NGK SPARK PLUG CO., LTD., Nagoya-shi (JP)

(21) Appl. No.: 16/910,179

(22) Filed: Jun. 24, 2020

(30) Foreign Application Priority Data
Jul. 2, 2019 (JP) 2019-123623

(51) Int. Cl. H01T 21/02; H01T 13/36; H01T 13/40; H01T 13/38

(52) U.S. Cl. CPC H01T 21/02; H01T 13/38; H01T 13/40; H01T 13/36

(57) ABSTRACT

A method for manufacturing a spark plug that includes preparing an assembly fitted with a cylindrical insulator, and a main metal fitting disposed on an outer periphery of the insulator; photographing the assembly by using a camera disposed on the axis while turning on a first lighting equipment disposed; photographing the assembly by using the camera while turning on a second lighting equipment; specifying a position of an outer peripheral surface of the insulator by using one of photographed images; specifying a position of an inner peripheral surface of the main metal fitting by using the other of the photographed images; and specifying a size of a clearance between the insulator and the main metal fitting by using the position of the outer peripheral surface of the insulator and the position of the inner peripheral surface of the main metal fitting.

### FIELD OF THE INVENTION

The present invention relates to a method for manufacturing a spark plug used for an internal combustion engine.

### BACKGROUND OF THE INVENTION

A spark plug is provided with an insulator and a main metal fitting disposed on the outer periphery of the insulator. The spark plug generates sparks in the gap formed between a center electrode disposed on the front end side of a shaft hole in the insulator and a ground electrode connected to the front end of the main metal fitting. In a case where the clearance between the insulator and the main metal fitting is not appropriately secured, failure, such as the generation of sparks between the center electrode and the main metal fitting (also referred to as lateral flying sparks), tends to occur. Therefore, in Japanese Patent Application Publication No. 2007-80638 (hereinafter is referred to as “JP2007-80638”), in the manufacturing process of the spark plug, a process for inspecting the clearance between the insulator and the main metal fitting is carried out.

In this technique, by using a digital camera, an image of the spark plug is taken from the front end side thereof along the axial direction, and by using this taken image, the clearance between the insulator and the main metal fitting is inspected.

However, in the above technique, the improvement of the photographing of the spark plug is not sufficiently considered, and, for example, there is possibility that the image of the edge of the insulator or the main metal fitting becomes unclear. Consequently, at least one of the position of the outer peripheral surface of the insulator and the position of the inner peripheral surface of the main metal fitting cannot be specified with high accuracy, as a result of which there is a case where the size of the clearance between the insulator and the main metal fitting cannot be specified with high accuracy.

### SUMMARY OF THE INVENTION

In view of the foregoing, it is desirable to provide a technique for specifying the size of the clearance between the insulator and the main metal fitting with high accuracy.

The present invention is one for solving at least a part of the above problem, and it can be realized by the following aspect.

A method for manufacturing a spark plug, includes: preparing an assembly fitted with a cylindrical insulator and a cylindrical main metal fitting, wherein the insulator is made of an insulation material, extends along an axis of the assembly, and is provided with a center electrode on an front end side in the axis, and the main metal fitting is made of a metal material, extends along the axis and is disposed on an outer periphery of the insulator; photographing the assembly by using a camera disposed on the axis more on the front end side than the assembly while turning on a first lighting equipment disposed more on the front end side than the assembly; photographing the assembly by using the camera while turning on a second lighting equipment disposed more on the front end side than the assembly so as to be disposed at a different position from the first lighting equipment; specifying a position of an outer peripheral surface of the insulator when viewing the assembly from the front end side in an axial direction, by using a first photographed image obtained in the photographing of the assembly while turning on the first lighting equipment; specifying a position of an inner peripheral surface of the main metal fitting when viewing the assembly from the front end side in the axial direction, by using a second photographed image obtained in the photographing of the assembly while turning on the second lighting equipment; and specifying a size of a clearance between the insulator and the main metal fitting by using the position of the outer peripheral surface of the insulator which is specified in the specifying of the position of the outer peripheral surface of the insulator and the position of the inner peripheral surface of the main metal fitting which is specified in the specifying of the position of the inner peripheral surface of the main metal fitting.

### BRIEF DESCRIPTION OF THE DRAWINGS

FIG. 1 is a sectional view when a spark plug 100 according to an embodiment of the present invention is cut along a surface including the axis of the spark plug 100.

FIG. 2 is a flowchart showing a process for a manufacturing method of the spark plug 100.

FIGS. 3A and 3B show a schematic diagram of the front end part of an assembly 100A.

FIG. 4 is a schematic diagram of an inspection device 1000 for clearance inspection.

FIGS. 5A, 5B, and 5C show an illustrative view of the inspection device 1000.

FIG. 6 is a flowchart showing a process of the clearance inspection.

### DETAILED DESCRIPTION OF THE INVENTION

### A. Embodiment

A-1. Configuration of Spark Plug:

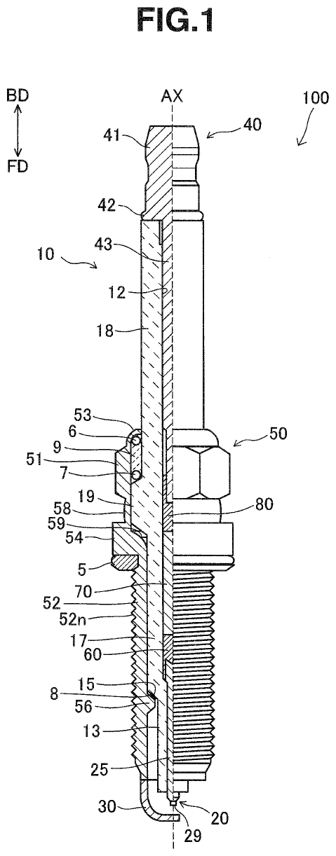

In the following, a mode for implementing the present invention will be explained based on an embodiment. FIG. 1 is a sectional view when a spark plug 100 according to an embodiment of the present invention is cut along a surface including the axis of the spark plug 100. A dashed line in FIG. 1 shows an axis AX of the spark plug 100. The direction parallel to the axis AX (vertical direction of FIG. 1) is also referred to as an axial direction. The radial direction of a circle on a surface which centers the AX and is vertical to the axis AX is also simply referred to as “radial direction”, and the circumferential direction of the circle is also simply referred to as “circumferential direction”. The lower direction in FIG. 1 is referred to as a front end direction FD, and the upper direction in FIG. 1 is referred to as a rear end direction BD. The lower side in FIG. 1 is referred to as the front end side of the spark plug 100, and the upper side in FIG. 1 is referred to as the rear end side of the spark plug 100.

The spark plug 100 is attached to an internal combustion engine, and is used for igniting combustion gas inside a combustion chamber of the internal combustion engine. The spark plug 100 is provided with an insulator 10, a center electrode 20, a ground electrode 30, a terminal metal fitting 40, a main metal fitting 50, a resistor 70, and seal members 60 and 80.

The insulator 10 is made of an insulation material, such as a ceramic consisting mainly of Al₂O₃ (alumina). The insulator 10 is a cylindrical member extending along the axial direction. The insulator 10 includes a shaft hole 12 which is a through hole penetrating through the insulator 10 so as to extend along the axial direction. The insulator 10 is provided with a flange portion 19, a rear-end-side body portion 18, a front-end-side body portion 17, a first reduced diameter portion 15, and a long leg portion 13. The rear-end-side body portion 18 is located more on the rear end side than the flange portion 19, and has an outer diameter smaller than that of the flange portion 19. The front-end-side body portion 17 is located more on the front end side than the flange portion 19, and has an outer diameter smaller than that of the flange portion 19. The long leg portion 13 is located more on the front end side than the front-end-side body portion 17, and has an outer diameter smaller than that of the front-end-side body portion 17. When the spark plug 100 is attached to the internal combustion engine (not shown), the long leg portion 13 is exposed to the combustion chamber of the internal combustion engine. The first reduced diameter portion 15 is formed between the long leg portion 13 and the front-end-side body portion 17. The outer diameter of the first reduced diameter portion 15 is reduced toward the front end side in the axial direction.

The main metal fitting 50 made of a metal material having conductivity (for example, a low carbon steel material) is a member for fixing the spark plug 100 to the engine head (not shown) of the internal combustion engine (see FIG. 1). The main metal fitting 50 has a cylindrical shape extending along the axial direction. The main metal fitting 50 is formed with a through hole 59 penetrating along the axis AX, and it is arranged on the outer periphery of the insulator 10. That is, the insulator 10 is inserted into and held in the through hole 59 of the main metal fitting 50. The front end of the insulator 10 is exposed more on the front end side than the front end of the main metal fitting 50. The rear end of the insulator 10 is exposed more on the rear end side than the rear end of the main metal fitting 50.

The main metal fitting 50 is provided with a tool engagement portion 51 having a hexagonal prism shape with which a spark plug wrench engages, an attachment screw portion 52 for the attachment to the internal combustion engine, and with a seat portion 54 having a flange shape which is formed between the tool engagement portion 51 and the attachment screw portion 52. The outer peripheral surface of the attachment screw portion 52 is formed with a male screw 52n. The nominal diameter of the male screw 52n is, for example, M8 to M18.

An annular gasket 5 formed by bending a metal plate is fitted between the attachment screw portion 52 and the seat portion 54 of the main metal fitting 50. The gasket 5 is provided to seal the gap between the spark plug 100 and the internal combustion engine (engine head) when the spark plug 100 is attached to the internal combustion engine.

The main metal fitting 50 is further provided with a thin caulking portion 53 provided on the rear end side of the tool engagement portion 51, and with a thin compressive deforming portion 58 provided between the seat portion 54 and the tool engagement portion 51. Annular ring members 6 and 7 are disposed in the annular area formed between a part of the inner peripheral surface of the main metal fitting 50 which extends from the tool engagement portion 51 to the caulking portion 53 and the outer peripheral surface of the rear-end-side body portion 18 of the insulator 10. The powder of a talc 9 is filled between the two ring members 6 and 7 in the area. The rear end of the caulking portion 53 is bent radially inward, and is fixed to the outer peripheral surface of the insulator 10. At the time of the manufacturing, the caulking potion 53 fixed to the outer peripheral surface of the insulator 10 is pressed to the front end side, and the compressive deforming portion 58 of the main metal fitting 50 is compressed and deformed. By the compression and deformation of the compressive deforming portion 58, the insulator 10 is pressed toward the front end side in the inside of the main metal fitting 50 via the ring members 6 and 7 and the talc 9. The first reduced diameter portion 15 of the insulator 10 is pressed by a shelf portion 56 formed on the inner periphery of the attachment screw portion 52 in the main metal fitting 50 via a metal annular plate packing 8. Accordingly, the gas inside the combustion chamber of the internal combustion engine is suppressed from leaking out to the outside from the gap between the main metal fitting 50 and the insulator 10 by the plate packing 8.

The terminal metal fitting 40 is a member having a stick shape which extends in the axial direction, and is disposed on the rear end side of the shaft hole 12 of the insulator 10. The terminal metal fitting 40 is made of a metal material having conductivity (for example, low carbon steel), and the surface of the terminal metal fitting 40 is formed with a metal layer (for example, Ni layer) for corrosion resistance by, for example, plating. The terminal metal fitting 40 is provided with a flange portion (terminal flange portion) 42 formed at a predetermined position in the axial direction, a cap mounting portion 41 located more on the rear end side than the flange portion 42, and with a leg portion (terminal led portion) 43 located more on the front end side than the flange portion 42. The cap mounting portion 41 of the terminal metal fitting 40 is exposed more on the rear end side than the insulator 10. The leg portion 43 of the terminal metal fitting 40 is inserted into the shaft hole 12 of the insulator 10. That is, the front end of the terminal metal fitting 40 is located more on the rear end side than the rear end of the center electrode 20 in the inside of the shaft hole 12, and the rear end of the terminal metal fitting 40 is exposed more on the rear end side than the insulator 10. A plug cap to which a high voltage cable (not shown) is connected is mounted on the cap mounting portion 41, and a high voltage is applied thereto to generate spark discharge.

The center electrode 20 is a member having a substantially stick shape which extends in the axial direction. The center electrode 20 is disposed on the front end side of the shaft hole 12 in the insulator 10. The rear end of the center electrode 20 is located inside the shaft hole 12, and the front end of the center electrode 20 is exposed more on the front end side than the insulator 10. The center electrode 20 is provided with a center electrode main body 25 having a substantially stick shape, and with a columnar center electrode tip 29 joined to the front end of the center electrode main body 25 (see FIG. 1).

The ground electrode 30 is a curved stick body of which the cross section is square. The rear end portion of the ground electrode 30 is joined to the front end surface of the main metal fitting 50 by welding. Accordingly, the main metal fitting 50 is electrically connected to the ground electrode 30. The front end of the ground electrode 30 is a free end. The gap between the center electrode tip 29 and the vicinity of the free end of the ground electrode 30 is a so-called spark gap at which spark discharge is generated. In addition, the ground electrode 30 may be equipped with, at a part where the spark gap is formed, a ground electrode tip similar to the center electrode tip 29.

The ground electrode 30 and the center electrode main body 25 are each made of, for example, nickel or an alloy containing nickel as a main component (for example, NCF 600, NCF 601). Each of the ground electrode 30 and the center electrode main body 25 may have a two-layer structure including a base member made of a metal having a high corrosion resistance (for example, nickel alloy) and a core made of a metal having a high conductivity (for example, copper) which is embedded in the base member. The center electrode tip 29 is made of a noble metal, such as Pt (platinum) and Ir (iridium), or an alloy containing the noble metal as a main component.

The resistor 70 is disposed between the front end of the terminal metal fitting 40 (front end of the leg portion 43) and the rear end of the center electrode 20 (rear end of the center electrode main body 25) in the inside of the shaft hole 12 of the insulator 10. That is, the resistor 70 is disposed more on the rear end side in the axial direction than the center electrode 20 in the inside of the shaft hole 12. For example, the resistor 70 has a resistance value equal to or greater than 1 kΩ (for example, 5 kΩ), and has a function for reducing electric wave noise at the time of the spark generation. The resistor 70 is made of a composition containing, for example, glass particles as a main component, ceramic particles except glass and a conductive material.

In the inside of the shaft hole 12, the seal member 60 is disposed between the resistor 70 and the center electrode 20 (center electrode main body 25), so as to fill the gap between the resistor 70 and the center electrode 20. In the inside of the shaft hole 12, the seal member 80 is disposed between the resistor 70 and the terminal metal fitting 40 (leg portion 43), so as to fill the gap between the resistor 70 and the terminal metal fitting 40. The seal members 60 and 80 are each made of a material having conductivity, such as a composition containing glass particles of B₂O₃—SiO₂ system and metal particles (for example, Cu and Fe). The resistance value of each of the seal members 60 and 80 is less than 1 kΩ, for example, several hundreds of mmΩ.

A-2. Method for Manufacturing Spark Plug 100:

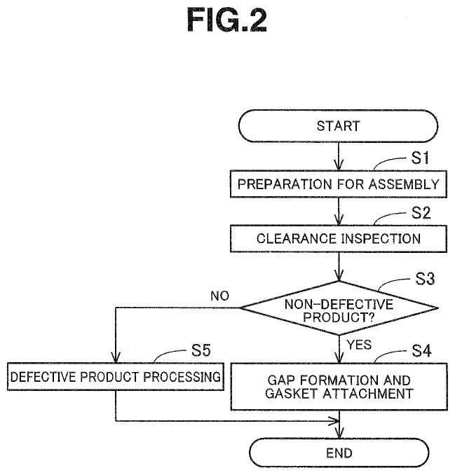

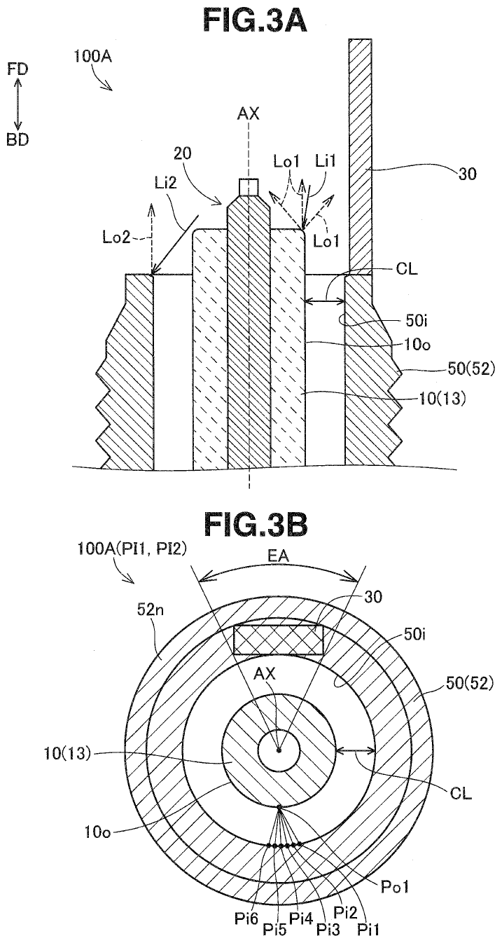

FIG. 2 is a flowchart showing a process for a manufacturing method of the spark plug 100. FIGS. 3A and 3B show a schematic diagram of the front end part of the assembly 100A. In FIG. 3A, a sectional view of the front end part of the assembly 100A including the axis AX is shown. In FIG. 3A, as opposed to FIG. 1, the front end direction FD is upward, and the rear end direction BD is downward. In FIG. 3B, a view of the front end part of the assembly 100A when viewed from the front end side to the rear end direction BD along the axis AX is shown.

In a step S1 in FIG. 2 in, the assembly 100A that is an intermediate product on the manufacturing process of the spark plug 100 is prepared. The assembly 100A differs from the spark plug 100 only in that, in the assembly 100A, the ground electrode 30 is not bent and the gasket 5 is not attached.

First, each member (insulator 10, center electrode 20, ground electrode 30, terminal metal fitting 40, main metal fitting 50, seal members 60 and 80, resistor 70) composing the spark plug 100 (assembly 100A) is prepared. The center electrode 20 and the terminal metal fitting 40 are inserted into the shaft hole 12 of the insulator 10, and are fitted to the insulator 10. At this time, in the inside of the shaft hole 12, the seal members 60 and 80 and the resistor 70 in FIG. 1 are sealed between the shaft hole 12 and the terminal metal fitting 40. The ground electrode 30 is joined to the front end surface of the main metal fitting 50 by, for example, resistance welding. The insulator 10 fitted with the center electrode 20 and the terminal metal fitting 40 is fitted to the main metal fitting 50, and then the assembly 100A is obtained.

In a step S2, clearance inspection is carried out. The clearance inspection is a process for inspecting whether or not the size of a clearance CL between the main metal fitting 50 and the insulator 10 is equal to or greater than a predetermined threshold value TH. As shown in FIG. 3A and FIG. 3B, the clearance CL is the minimum gap distance in the radial direction between the outer peripheral surface of the front end part (long leg portion 13) of the insulator 10 and the inner peripheral surface of the front end part (a part on the front end side from the shelf portion 56 in the attachment screw portion 52) of the main metal fitting 50. In the clearance inspection, if the size of the clearance CL is equal to or greater than the predetermined threshold value TH, it is determined that the assembly 100A is a non-defective product, and if the size of the clearance CL is less than the predetermined threshold value TH, it is determined that the assembly 100A is a defective product. The clearance inspection will be explained below.

As a result of the clearance inspection, in a case where the assembly 100A is determined as a non-defective product (“YES” in a step S3), the assembly 100A is transferred to the next process (step S4). For example, in the step S4, gap formation and gasket attachment are carried out to the assembly 100A. In the gap formation, bending is carried out to the ground electrode 30 of the assembly 100A. With this bending, a spark gap for generating spark discharge is formed between the front end surface of the center electrode 20 (center electrode tip 29) and the ground electrode 30. In the gasket attachment, as shown in FIG. 1, the gasket 5 is attached to the front end side of the seat portion 54. By passing through the above steps, the spark plug 100 is completed.

As a result of the clearance inspection, in a case where the assembly 100A is determined as a defective product (“NO” in the step S3), the assembly 100A is transferred to defective product processing of a step S5. For example, the defective product processing may be disposal processing of the assembly 100A, or may be processing for adjusting the clearance CL.

A-3. Inspection Device for Clearance Inspection:

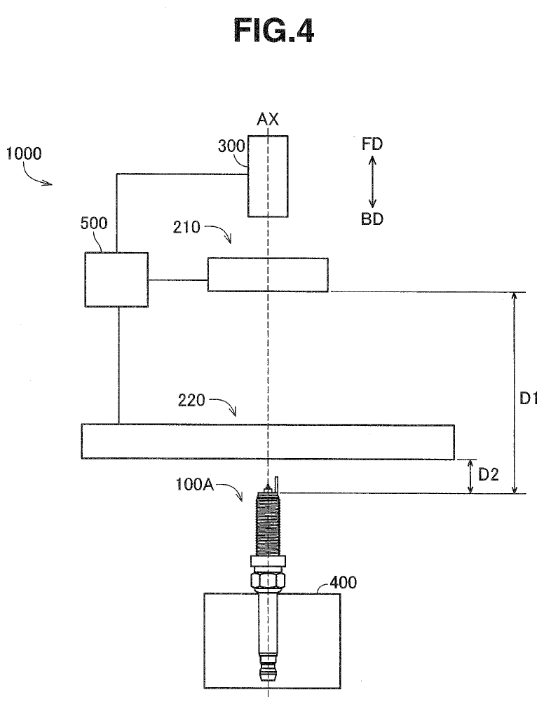

FIG. 4 is a schematic diagram of the inspection device 1000 for the clearance inspection. As mentioned above, the assembly 100A differs from the spark plug 100 only in that, in the assembly 100A, the ground electrode 30 is not bent and the gasket 5 is not attached. The axis AX of the assembly 100A therefore corresponds to the axis AX of the spark plug 100. Here, the axis AX of the assembly 100A in a state in which the assembly 100A is fixed to a fixing table 400 of the inspection device 1000 is defined as an axis AX of the inspection device 1000. Then, in FIG. 4, a radial direction of a circle on a surface which centering the axis AX and is vertical to the axis AX is also simply referred to as “radial direction”, and the circumferential direction of the circle is also simply referred to as “circumferential direction”. In addition, the upper direction in FIG. 4 is also referred to as a front end direction FD, and the lower direction in FIG. 4 is also referred to as a rear end direction BD. The upper side in FIG. 4 is referred to as the front end side of the inspection device 1000, and the lower side in FIG. 4 is referred to as the rear end side of the inspection device 1000.

As shown in FIG. 4, the inspection device 1000 is provided with the fixing table 400 for fixing the assembly 100A, a digital camera 300, a first lighting equipment 210, a second lighting equipment 220, and a control unit 500.

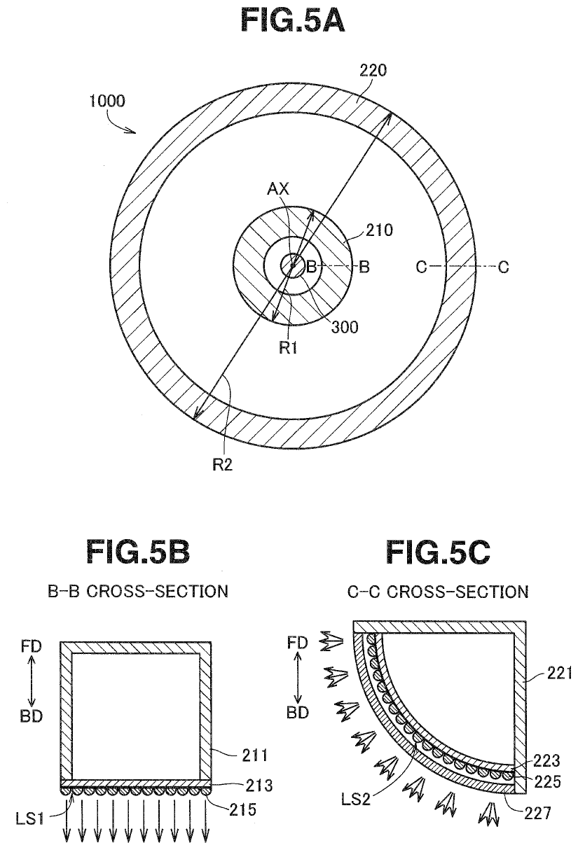

FIG. 5A is a view of the inspection device 1000 when viewed from the front end side (from the upper side of FIG. 4) to the rear end direction BD in the axis AX. In FIG. 5A, to simplify the view thereof, in the inspection device 1000, only the digital camera 300, the first lighting equipment 210 and the second lighting equipment 220 are shown, and the digital camera 300, the first lighting equipment 210 and the second lighting equipment 220 are each shown by hatching.

The digital camera 300 is a device to obtain, by photographing an object (for example, assembly 100A) by using a two-dimensional image sensor, such as a CCD element, the photographed image showing the object. In the present embodiment, the photographed image is a monochromatic image. The digital camera 300 is disposed more on the front end side than the assembly 100A, and is arranged on the axis AX. The digital camera 300 is therefore able to photograph an image of the assembly 100A viewed from the front end side to the rear end direction BD along the axis AX.

The first lighting equipment 210 is lighting equipment having an annular shape centering the axis AX of which the radial direction and the circumferential direction are vertical to the axis AX. FIG. 5B is a sectional view showing a cross-section (B-B cross-section in FIG. 5A) of a part of the lighting equipment 210 which is taken by cutting a surface including the axis AX. The first lighting equipment 210 is disposed more on the front end side than the spark plug 100 in the axis AX.

The first lighting equipment 210 is provided with an annular housing 211, a substrate 213 fixed to the rear end direction BD side of the housing 211, and a plurality of light emitting elements 215. The substrate 213 is a plate arranged vertical to the axis AX. The shape of the substrate 213 when viewed from the rear end side along the axis AX is an annular shape. Each of a plurality of the light emitting elements 215 is a white light emitting diode (LED) in the present embodiment. A plurality of the light emitting elements 215 are arranged over the whole surface on the rear end side (lower side of FIG. 5B) of the substrate 213. A light emitting surface LS1 of the first lighting equipment 210 which is formed by a plurality of the light emitting elements 215 is a surface which is vertical to the axis AX and faces the rear end side. The shape of the light emitting surface LS1 when viewed from the rear end side along the axis AX is an annular shape. The first lighting equipment 210 is different from the second lighting equipment 220 explained below, and is provided with no diffusion member. The light emitted from a plurality of the light emitting elements 215 has directivity, and in the present embodiment, it is emitted to the rear end direction BD.

The second lighting equipment 220 is lighting equipment having an annular shape centering around the axis AX of which the radial direction and the circumferential direction are vertical to the axis AX. FIG. 5C is a sectional view showing a cross-section (C-C cross-section in FIG. 5A) of a part of the lighting equipment 220 which is taken by cutting a surface including the axis AX. The second lighting equipment 220 is disposed more on the front end side than the spark plug 100 in the axis AX, and is disposed more on the rear end side than the first lighting equipment 210 in the axis AX.

The second lighting equipment 220 is provided with an annular housing 221, a substrate 223 fixed to the housing 221, a plurality of light emitting elements 225, and a diffusion member 227 fixed to the housing 221. The substrate 223 is a plate curved in a convex shape in the cross-section shown in FIG. 5C. The shape of the substrate 223 when viewed from the rear end side along the axis AX is an annular shape. Each of a plurality of the light emitting elements 225 is a white light emitting diode (LED) in the present embodiment. A plurality of the light emitting elements 225 are arranged over the whole surface on the outer side of the substrate 223 (surface facing the assembly 100A side). A light emitting surface LS2 of the second lighting equipment 220 which is formed by a plurality of the light emitting elements 225 faces the assembly 100A fixed to the fixing table 400, and is a curved surface having a curved line in the cross section (for example, C-C cross-section shown in FIGS. 5A, 5B, and 5C) including the axis AX. The shape of the light emitting surface LS2 when viewed from the rear end side along the axis AX is an annular shape.

The diffusion member 227 is, for example, a thin resin plate formed with, on the surface thereof, fine recesses and protrusions. The diffusion member 227 has the same shape as the light emitting surface LS2, and covers the light emitting surface LS2. When the light emitted from the light emitting surface LS2 passes through the diffusion member 227, by the diffusion member 227, the direction of the light is diffused to several directions. Due to that the light emitting surface LS2 is curved and the light emitting surface LS2 is covered with the diffusion member 227, the light emitted from the second lighting equipment 220 includes light advancing in several directions.

As shown in FIG. 4, the distance along the axis AX between the front end of the main metal fitting 50 of the assembly 100A fixed to the fixing table 400 and the rear end of the first lighting equipment 210 is defined as a distance D1. In addition, the distance along the axis AX between the front end of the main metal fitting 50 of the assembly 100A fixed to the fixing table 400 and the rear end of the second lighting equipment 220 is defined as a distance D2. The distance D1 is longer than the distance D2 (D1>D2). For example, the distance D1 is five to fifteen times longer than the distance D2.

As shown in FIG. 5A, the outer diameter of the light emitting surface LS1 of the first lighting equipment 210 is defined as an outer diameter R1, and the outer diameter of the second light emitting surface LS2 of the second lighting equipment 220 is defined as an outer diameter R2. The outer diameter R2 is larger than the outer diameter R1 (R2>R1). For example, the outer diameter R2 is two to five times larger than the outer diameter R1.

The control unit 500 is a well-known computer equipped with a CPU (center processing unit) and a memory. The control unit 500 is connected to the digital camera 300, the first lighting equipment 210 and the second lighting equipment 220 via well-known interfaces. The control unit 500 is configured to control the digital camera 300 so as to photograph the assembly 100A, and thereby a photographed image of the assembly 100A can be obtained from the digital camera 300. In addition, the control unit 500 is capable of controlling turning on/off of the first lighting equipment 210 and the second lighting equipment 220.

A-4. Process for Clearance Inspection:

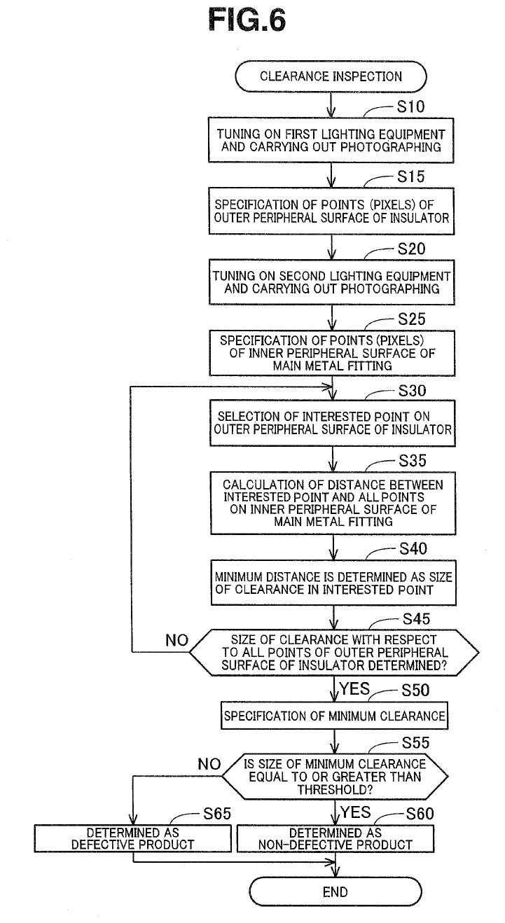

FIG. 6 is a flowchart showing a process for clearance inspection. The clearance inspection is started in a state in which the assembly 100A is fixed to the fixing table 400 by an inspector. In a step S10, the control unit 500 turns on the first lighting equipment 210, and executes photographing by the digital camera 300. With this, the control unit 500 obtains a first photographed image PI1 from the digital camera 300. As shown in FIG. 3B, the first photographed image PI1 is an image of the assembly 100A when viewed from the front end side to the rear end direction BD along the axis AX.

In a step S15, by using the first photographed image PI1, the control unit 500 specifies points Po indicating the position of an outer peripheral surface 10o (FIG. 3B) of the insulator 10. That is, the control unit 500 specifies a plurality of edge pixels indicating the outer peripheral surface 10o of the insulator 10 (long leg portion 13) from a plurality of pixels constituting the first photographed image PI1 by analyzing the first photographed image PI1. Since the coordinates of the edge pixels indicate the points Po indicating the position of the outer peripheral surface 10o, the specifying of the edge pixels means the specifying of the points Po indicating the position of the outer peripheral surface 10o. In FIG. 3B, although only one point Po1 is shown as an example, any number of a plurality of points Po over the entire periphery of the outer peripheral surface 10o are specified.

In a step S20, the control unit 500 turns on the second lighting equipment 220, and executes photographing by the digital camera 300. With this, the control unit 500 obtains a second photographed image PI2 from the digital camera 300. As shown in FIG. 3B, similar to the first photographed image PI1, the second photographed image PI2 is an image when the assembly 100A is viewed from the front end side toward the rear end direction BD along the axis AX. The first photographed image PI1 and the second photographed image PI2 are taken under the same photographing condition, without moving the digital camera 300. Consequently, a coordinate in the first photographed image PI1 corresponds to a coordinate in the second photographed image PI2 at the same position in the real space.

In a step S25, by using the second photographed image PI2, the control unit 500 specifies points Pi of an inner peripheral surface 50i (FIG. 3B) of the main metal fitting 50 (front end part of the screw attachment portion 52). That is, the control unit 500 specifies a plurality of edge pixels indicating the inner peripheral surface 50i of the main metal fitting 50 from a plurality of pixels constituting the second photographed image PI2 by analyzing the second photographed image PI2. The coordinates of a plurality of the specified edge pixels are the points Pi of the inner peripheral surface 50i (FIG. 3B). In FIG. 3B, although only six points Pi1 to Pi6 are shown as an example, any number of a plurality of points Pi over the entire periphery of the inner peripheral surface 50i are specified. In addition, there is a case where points of the inner peripheral surface 50i within a circumferential direction range EA in which the ground electrode 30 is disposed become unclear on the second photographed image PI2 due to the joining part of the main metal fitting 50 and the ground electrode 30 becoming a complicated shape. In this case, the points of the inner peripheral surface 50i within the range EA are defined as points on a virtual circle specified by points of the inner peripheral surface 50i outside the range EA.

In a step S30, the control unit 500 selects one interested point from a plurality of the points Po of the outer peripheral surface 10o which are specified by using the first photographed image PI1. For example, a point Po1 shown in FIG. 3B is selected as an interested point.

In a step S35, the control unit 500 calculates the distances between the interested point and all points of the inner peripheral surface 50i of the main metal fitting 50 which are specified by using the second photographed image PI2. For example, when the point Po1 shown in FIG. 3B is the interested point, the distance between the interested point Po1 and each of all the points on the inner peripheral surface 50i including the points Pi1 to Pi6 is calculated.

In a step S40, the control unit 500 determines the minimum distance of a plurality of the distances calculated in the step S35 to the size of a clearance corresponding to the interested point.

In a step S45, the control unit 500 determines whether or not the sizes of clearances with respect to all the points of the outer peripheral surface 10o specified in the step S15 are determined. When there is a point at which the size of the clearance is not determined (“NO” in the step S45), the process executed by the control unit 500 is returned from the step S45 to the step S30. When the sizes of the clearances with respect to all the points are determined (“YES” in the step S45), in a step S50, the control unit 500 specifies a minimum clearance CL from the clearances determined with respect to all the points of the outer peripheral surface 10o.

In a step S55, the control unit 500 determines whether or not the size of the minimum clearance CL specified in the step S50 is equal to or greater than a predetermined threshold value TH.

When the size of the minimum clearance CL is equal to or greater than the threshold value TH (“YES” in the step S55), in a step S60, the control unit 500 determines that the assembly 100A is a non-defective product. When the size of the minimum clearance CL is less than the threshold value TH (“NO” in the step S55), in a step S65, the control unit 500 determines that the assembly 100A is a defective product.

According to the present embodiment explained above, the method for manufacturing the spark plug 100 (see FIG. 2 and FIG. 6), includes: preparing (step S1 in FIG. 2) the assembly 100A; photographing (step S10 in FIG. 6) the assembly 100A by using the camera 300 while turning on the first lighting equipment 210; photographing (step S20 in FIG. 6) the assembly 100A by using the camera 300 while turning on the second lighting equipment 220 disposed at a different position from the first lighting equipment 210; specifying (step S15 in FIG. 6) the position of the outer peripheral surface 10o of the insulator 10 when viewing the assembly 100A from the front end side in the axial AX direction, by using the first photographed image PI1 obtained in the photographing of the assembly 100A while turning on the first lighting equipment 210; specifying (step S25 in FIG. 6) the position of the inner peripheral surface 50i of the main metal fitting 50 when viewing the assembly 100A from the front end side in the axial AX direction, by using the second photographed image PI2 obtained in the photographing of the assembly 100A while turning on the second lighting equipment 220; and specifying (steps S30-S50 in FIG. 6) the size of the clearance CL between the insulator 10 and the main metal fitting 50 by using the position of the outer peripheral surface 10o of the insulator 10 which is specified in the specifying of the position of the outer peripheral surface 10o of the insulator 10 and the position of the inner peripheral surface 50i of the main metal fitting 50 which is specified in the specifying of the position of the inner peripheral surface 50i of the main metal fitting 50. Consequently, for example, even in a case where a property of reflecting light is different between the insulator 10 made of an insulation material and the main metal fitting 50 made of a metal material, as compared with a case of using only one photographed image, the position of the outer peripheral surface 10o of the insulator 10 and the position of the inner peripheral surface 50i of the main metal fitting 50 can be both specified with high accuracy. Therefore, the size of the clearance CL between the insulator 10 and the main metal fitting 50 can be specified with high accuracy.

The reflection of the light in the surface of the insulator 10 made of an insulation material is mainly dispersion reflection. As shown in FIG. 3A, when a light Li1 is emitted from one direction to the surface of the insulator 10, reflected lights Lo1 are dispersed to various directions. Consequently, when light is emitted from one direction toward the insulator 10, reflected light from the insulator 10 toward the digital camera 300 is generated. Therefore, if a sufficient amount of light is emitted from one direction to the insulator 10 so as to secure a sufficient amount of light toward the digital camera 300, a clear image of the insulator 10 can be obtained. If light is emitted from various directions to the insulator 10, since reflected light in various directions corresponding to the light emitted from various directions travels toward the digital camera 300, the amount of light traveling toward the digital camera 300 becomes insufficient, and the image of the insulator 10 tends to be unclear.

On the other hand, the reflection of the light in the surface of the main metal fitting 50 made of a metal material is mainly mirror reflection. As shown in FIG. 3A, when a light Li2 is emitted from one direction to the surface of the main metal fitting 50, the light Li2 is reflected to one direction as a reflected light Lo2. Consequently, even if light is emitted from one direction to the surface of the main metal fitting 50, there is a case where, in a part of the surface, reflected light traveling toward the digital camera 300 is not generated. In this case where the reflected light traveling toward the digital camera 300 is not generated, in the photographed image, this part becomes dark, and the image of this part cannot be obtained. It is therefore preferable to emit light from various directions to the surface of the main metal fitting 50. In this case, a reflected light corresponding to at least one of lights emitted from various directions travels toward the digital camera 300, and, in the photographed image, a bright and clear image of the main metal fitting 50 can be obtained.

In this way, it is preferable to emit light from one direction to the insulator 10, and to emit light from various directions to the main metal fitting 50. In the present embodiment, the first lighting equipment 210 and the second lighting equipment 220 are improved so as to emit such light to the insulator 10 and the main metal fitting 50.

For example, in the present embodiment, the distance D1 along the axis between the first lighting equipment 210 and the assembly 100A is longer than the distance D2 along the axis between the second lighting equipment 220 and the assembly 100A. Consequently, since light is emitted from the first lighting equipment 210 located at a position relatively away from the assembly 100A to the insulator 10, light aligned in one direction can be emitted to the insulator 10. In addition, since light is emitted from the second lighting equipment 220 located at a position relatively close to the assembly 100A to the main metal fitting 50, light from various directions can be emitted to the main metal fitting 50. Therefore, by using the first lighting equipment 210, the first photographed image PI1 in which the image of the insulator 10 is clearly taken can be obtained. In addition, by using the second lighting equipment 220, the second photographed image PI2 in which the image of the main metal fitting 50 is clearly taken can be obtained. Then, by using the photographed images PI1 and PI2, the position of the outer peripheral surface 10o of the insulator 10 and the position of the inner peripheral surface 50i of the main metal fitting 50 can be both specified with high accuracy.

Moreover, in the present embodiment, the first lighting equipment 210 and the second lighting equipment 220 respectively have the light emitting surfaces LS1 and LS2 each having an annular shape when viewed from the rear end side in the axial direction, and the outer diameter R2 of the light emitting surface LS2 of the second lighting equipment 220 is larger than the outer diameter R1 of the light emitting surface LS1 of the first lighting equipment 210 (see FIG. 5A). With this, by emitting light from the first lighting equipment 210 having a relatively small outer diameter to the insulator 10, light aligned in one direction can be emitted to the insulator 10. In addition, by emitting light from the second lighting equipment 220 having a relatively large outer diameter to the main metal fitting 50, light in various directions can be emitted to the main metal fitting 50. Consequently, the first photographed image PI1 in which the image of the insulator 10 is clearly taken and the second photographed image PI2 in which the image of the main metal fitting 50 is clearly taken can be obtained. Therefore, the position of the outer peripheral surface 10o of the insulator 10 and the position of the inner peripheral surface 50i of the main metal fitting 50 can be both specified with high accuracy.

Moreover, in the present embodiment, as shown in FIG. 5C, the light emitting surface LS2 of the second lighting equipment 220 faces the assembly 100A, and is a curved surface having a curved line in the cross-section including the axis AX. Consequently, the second lighting equipment 220 is capable of emitting light in various directions from the light emitting surface LS2 which is a curved surface, and thereby light in more various directions can be emitted from the second lighting equipment 220 to the main metal fitting 50 of the assembly 100A. Therefore, the second photographed image PI2 in which the image of the main metal fitting 50 is more clearly taken can be obtained, and the position of the inner peripheral surface 50i of the main metal fitting 50 can be specified with higher accuracy.

Moreover, in the present embodiment, as shown in FIG. 5B, the light emitting surface LS1 of the first lighting equipment 210 faces the assembly 100A, and is a plane surface vertical to the axis AX. Consequently, the first lighting equipment 210 is capable of emitting light in one direction from the light emitting surface LS1 which is a plane surface, and thereby light more aligned in one direction can be emitted from the first lighting equipment 210 to the insulator 10 of the assembly 100A. Therefore, the first photographed image PI1 in which the image of the insulator 10 is more clearly taken can be obtained, and the position of the outer peripheral surface 10o of the insulator 10 can be specified with higher accuracy.

Moreover, in the present embodiment, as shown in FIG. 5B and FIG. 5C, although the first lighting equipment 210 is not provided with a diffusion member, the second lighting equipment 220 is provided with the diffusion member 227. That is, of the first lighting equipment 210 and the second lighting equipment 220, only the second lighting equipment 220 is provided with the diffusion member 227 disposed between a light source (light emitting elements 225) and the assembly 100A. Since the second lighting equipment 220 is provided with the diffusion member 227, light in more various directions can be emitted from the second lighting equipment 220 to the main metal fitting 50. Furthermore, since the first lighting equipment 210 is not provided with a diffusion member, light more aligned in one direction can be emitted from the first lighting equipment 210 to the insulator 10. Consequently, the first photographed image PI1 in which the image of the insulator 10 is more clearly taken and the second photographed image PI2 in which the image of the main metal fitting 50 is more clearly taken can be obtained, and thereby the position of the outer peripheral surface 10o of the insulator 10 and the position of the inner peripheral surface 50i of the main metal fitting 50 can be both specified with higher accuracy.

Moreover, according to the present invention, in the specifying of the position of the outer peripheral surface 10o of the insulator 10 (step S15 in FIG. 6), a plurality of the points (edge pixels) Po indicating the position of the outer peripheral surface 10o of the insulator 10 are specified. In the specifying of the position of the inner peripheral surface 50i of the main metal fitting 50 (step S25 in FIG. 6), a plurality of the points (edge pixels) Pi indicating the position of the inner peripheral surface 50i of the main metal fitting 50 are specified. In the specifying of the size of the clearance CL (step S30 to step S50 in FIG. 6), the distances for all the combinations of a plurality of the points Po indicating the position of the outer peripheral surface 10o and a plurality of the points Pi indicating the position of the inner peripheral surface 50i are calculated (step S35), and a minimum value of the distances for all the combinations is specified as a minimum value of the clearance between the insulator 10 and the main metal fitting 50 (see step 40 and step S0 in FIG. 6). Accordingly, the minimum value of the clearance between the insulator 10 and the main metal fitting 50 can be appropriately specified. In a case where, for example, the distance on the line passing the axis AX and extending radially between the outer peripheral surface 10o of the insulator 10 and the inner peripheral surface 50i of the main metal fitting 50 is defined as a clearance, there is a case where, for example, if the distortion of the outer peripheral surface 10o of the insulator 10 or the inner peripheral surface 50i of the main metal fitting 50 is large, the minimum value of the clearance cannot be appropriately specified. However, in the present embodiment, even if the distortion of the outer peripheral surface 10o of the insulator 10 or the inner peripheral surface 50i of the main metal fitting 50 is large, the minimum value of the clearance can be appropriately specified.

Moreover, according to the present embodiment, in a case where the size of the clearance CL specified in the specifying of the size of the clearance CL (steps S30 to S50 in FIG. 6) is equal to or greater than a predetermined value (threshold value TH) (“YES” in step S55 in FIG. 6), the assembly 100A is determined as a non-detective product (step S60 in FIG. 6), and the assembly 100A determined as a non-detective product is transferred to the next process (step S4 in FIG. 2). Accordingly, the spark plug 100 in which the clearance CL between the insulator 10 and the main metal fitting 50 is appropriately secured can be manufactured.

### B. Variation

(1) The inspection device 1000 of the above embodiment is one embodiment, and it is not limited to this. Although, in the above embodiment, the distance D2 between the second lighting equipment 220 and the assembly 100A is shorter than the distance D1 between the first lighting equipment 210 and the assembly 100A and the outer diameter R2 of the second lighting equipment 220 is larger than the outer diameter R1 of the first lighting equipment 210, for example, the distance D1 between the first lighting equipment 210 and the assembly 100A may be equal to the distance D2 between the second lighting equipment 220 and the assembly 100A and the outer diameter R2 of the second lighting equipment 220 is larger than the outer diameter R1 of the first lighting equipment 210. In another way, the distance D2 between the second lighting equipment 220 and the assembly 100A is shorter than the distance D1 between the first lighting equipment 210 and the assembly 100A and the outer diameter R2 of the second lighting equipment 220 may be equal to the outer diameter R1 of the first lighting equipment 210. In another way, the distance D2 between the second lighting equipment 220 and the assembly 100A may be longer than the distance D1 between the first lighting equipment 210 and the assembly 100A and the outer diameter R2 of the second lighting equipment 220 may be remarkably larger than the outer diameter R1 of the first lighting equipment 210.

(2) Although, in the above embodiment, the light emitting surface LS2 of the second lighting equipment 220 is a curved surface and the second lighting equipment 220 is provided with the diffusion member 227, the light emitting surface LS2 of the second lighting equipment 220 is a curved surface and the second lighting equipment 220 may not be provided with the diffusion member 227. In another way, the light emitting surface LS2 of the second lighting equipment 220 may be a plane surface and the second lighting equipment 220 is provided with the diffusion member 227. In addition, in the cross-section including the axis AX, the light emitting surface LS2 of the second lighting equipment 220 may be a curved line protruding toward the rear end direction BD of the axis AX, or may be a concave curved line.

(3) An incandescent lamp or a fluorescent lamp may be used as the light source of one or both of the first lighting equipment 210 and the second lighting equipment 220 instead of the light emitting diodes. In addition, the light emitted from one or both of the first lighting equipment 210 and the second lighting equipment 220 may be, for example, blue or red light instead of white light. Moreover, the light quantity of the first lighting equipment 210 may be equal to the light quantity of the second lighting equipment 220.

(4) The inspection process (FIG. 6) of the above embodiment is one example, and it is not limited to this. For example, in the above embodiment, in all the combinations of the points of the outer peripheral surface 10o of the insulator 10 which are located in the whole range in the circumferential direction and the points of the inner peripheral surface 50i of the main metal fitting 50 which are located in the whole range in the circumferential direction, the distances between the points of the outer peripheral surface 10o and the points of the inner peripheral surface 50i are calculated. Instead of this, in all the combinations of the points of the outer peripheral surface 10o of the insulator 10 which are located in a part of the range in the circumferential direction and the points of the inner peripheral surface 50i of the main metal fitting 50 which are located in a part of the range in the circumferential direction where it is estimated that the clearance can be obtained, the distances between the points of the outer peripheral surface 10o and the points of the inner peripheral surface 50i may be calculated.

(5) In the step S25 of the above embodiment, in a case where the points of the inner peripheral surface 50i within the range EA are defined as points on a virtual circle specified by the points of the inner peripheral surface 50i outside the range EA, there is a case where, due to the joining part of the main metal fitting 50 and the ground electrode 30 becoming a complicated shape, the clearance within the range EA which is determined in the step S40 differs from the actual clearance. Therefore, in consideration of this, the threshold value TH in the step S55 may be different between a case where the minimum clearance CL is located within the range EA and a case where it is located outside the range EA.

The following summarizes features of the present embodiment.

[Application 1]

A method for manufacturing a spark plug, includes: preparing an assembly fitted with a cylindrical insulator and a cylindrical main metal fitting, wherein the insulator is made of an insulation material, extends along an axis of the assembly, and is provided with a center electrode on an front end side in the axis, and the main metal fitting is made of a metal material, extends along the axis and is disposed on an outer periphery of the insulator; photographing the assembly by using a camera disposed on the axis more on the front end side than the assembly while turning on a first lighting equipment disposed more on the front end side than the assembly; photographing the assembly by using the camera while turning on a second lighting equipment disposed more on the front end side than the assembly so as to be disposed at a different position from the first lighting equipment; specifying a position of an outer peripheral surface of the insulator when viewing the assembly from the front end side in an axial direction, by using a first photographed image obtained in the photographing of the assembly while turning on the first lighting equipment; specifying a position of an inner peripheral surface of the main metal fitting when viewing the assembly from the front end side in the axial direction, by using a second photographed image obtained in the photographing of the assembly while turning on the second lighting equipment; and specifying a size of a clearance between the insulator and the main metal fitting by using the position of the outer peripheral surface of the insulator which is specified in the specifying of the position of the outer peripheral surface of the insulator and the position of the inner peripheral surface of the main metal fitting which is specified in the specifying of the position of the inner peripheral surface of the main metal fitting. According to this configuration, by using the first photographed image photographed while tuning on the first lighting equipment, the position of the outer peripheral surface of the insulator is specified, and by using the second photographed image photographed while tuning on the second lighting equipment, the position of the inner peripheral surface of the main metal fitting is specified. Consequently, for example, even in a case where a property of reflecting light is different between the insulator made of an insulation material and the main metal fitting made of a metal material, as compared with a case of using only one photographed image, the position of the outer peripheral surface of the insulator and the position of the inner peripheral surface of the main metal fitting can be both specified with high accuracy. Therefore, the size of the clearance between the insulator and the main metal fitting can be specified with high accuracy.

[Application 2]

In the manufacturing method described in the application 1, a distance in a direction along the axis between the first lighting equipment and the assembly is longer than a distance in a direction along the axis between the second lighting equipment and the assembly. The reflection of the light in the surface of the insulator made of an insulation material is mainly dispersion reflection. Therefore, light is emitted from one direction to the insulator such that, of reflected and dispersed lights in various directions, a reflected light traveling toward the camera is made to be sufficient, and thereby a clear image of the insulator can be obtained. On the other hand, the reflection of the light in the surface of the main metal fitting made of a metal material is mainly mirror reflection. Therefore, light is emitted from various directions to the surface of the main metal fitting such that the light mirror-reflected surely travels toward the camera, and thereby a clear image of the main metal fitting can be obtained. In this way, it is preferable to emit light to the insulator from one direction, and to emit light to the main metal fitting from various directions. According to this configuration, since the distance between the first lighting equipment and the assembly is longer than the distance between the second lighting equipment and the assembly, light aligned in one direction can be emitted from the first lighting equipment to the insulator of the assembly, and light in various directions can be emitted from the second lighting equipment to the main metal fitting of the assembly. Consequently, the first photographed image in which the image of the insulator is clearly taken and the second photographed image in which the image of the main metal fitting is clearly taken can be obtained. Then, the position of the outer peripheral surface of the insulator and the position of the inner peripheral surface of the main metal fitting can be both specified with high accuracy.

[Application 3]

In the manufacturing method described in the application 1 or 2, the first lighting equipment and the second lighting equipment include respective light emitting surfaces and each having an annular shape when viewed from a rear end side in the axial direction, and an outer diameter of the light emitting surface of the second lighting equipment is larger than an outer diameter of the light emitting surface of the first lighting equipment. According to this configuration, light aligned in one direction can be emitted from the first lighting equipment to the insulator of the assembly. In addition, light in various directions can be emitted from the second lighting equipment to the main metal fitting of the assembly. Consequently, the first photographed image in which the image of the insulator is clearly taken and the second photographed image in which the image of the main metal fitting is clearly taken can be obtained. Therefore, the position of the outer peripheral surface of the insulator and the position of the inner peripheral surface of the main metal fitting can be both specified with high accuracy.

[Application 4]

In the manufacturing method described in any of the applications 1 to 3, the light emitting surface of the second lighting equipment faces the assembly, and is a curved surface which becomes a curved line in a cross-section including the axis. According to this configuration, light in more various directions can be emitted from the second lighting equipment to the main metal fitting of the assembly. Therefore, the second photographed image in which the image of the main metal fitting is more clearly taken can be obtained, and the position of the inner peripheral surface of the main metal fitting can be specified with high accuracy.

[Application 5]

In the manufacturing method described in any of the applications 1 to 4, of the first lighting equipment and the second lighting equipment, only the second lighting equipment is provided with a diffusion member between a light source of the second lighting equipment and the assembly. According to this configuration, since the second lighting equipment is provided with the diffusion member, light in more various directions can be emitted from the second lighting equipment to the main metal fitting of the assembly. Furthermore, since the first lighting equipment is not provided with a diffusion member, light more aligned in one direction can be emitted from the first lighting equipment to the insulator of the assembly. Consequently, the first photographed image in which the image of the insulator is more clearly taken and the second photographed image in which the image of the main metal fitting is more clearly taken can be obtained, and thereby the position of the outer peripheral surface of the insulator and the position of the inner peripheral surface of the main metal fitting can be both specified with higher accuracy.

[Application 6]

The manufacturing method described in any of the applications 1 to 5, in the specifying of the position of the outer peripheral surface of the insulator, a plurality of first points indicating the position of the outer peripheral surface of the insulator are specified, in the specifying of the position of the inner peripheral surface of the main metal fitting, a plurality of second points indicating the position of the inner peripheral surface of the main metal fitting are specified, in the specifying of the size of the clearance, distances for all combinations of the first points located within a specific range in a circumferential direction and the second points located within the specific range are calculated, and a minimum value of the calculated distances for all the combinations is specified as a minimum value of the clearance in the specific range. According to this configuration, the minimum value of the clearance between the insulator and the main metal fitting in the specific range can be appropriately specified.

[Application 7]

In the manufacturing method described in any of the applications 1 to 6, when the size of the clearance is equal to or greater than a predetermined value, the assembly is determined as a non-detective product, and then the assembly determined as a non-detective product is transferred to a next process. According to this configuration, the spark plug in which the clearance between the insulator and the main metal fitting is appropriately secured can be manufactured.

The art described above can be embodied in various aspects such as a method for manufacturing a spark plug, a method for measuring a clearance, a device for measuring a clearance, and a spark plug manufactured by using the manufacturing method and these measuring methods.

The entire contents of Japanese Patent Application 2019-123623 filed Jul. 2, 2019 is incorporated herein by reference.

Although the present invention has been described with reference to the present embodiment and its variations, the present embodiment and its variations are intended to facilitate understanding of the present invention and are not intended to limit the present invention thereto. Various changes and modifications may be made to the present embodiment and its variations without departing from the scope of the present invention. The present invention includes equivalents thereof.

What is claimed is:

1. A method for manufacturing a spark plug, comprising:
preparing an assembly fitted with a cylindrical insulator and a cylindrical main metal fitting, wherein the insulator is made of an insulation material, extends along an axis of the assembly, and is provided with a center electrode on an front end side in the axis, and the main metal fitting is made of a metal material, extends along the axis and is disposed on an outer periphery of the insulator;
photographing the assembly by using a camera disposed on the axis more on the front end side than the assembly while turning on a first lighting equipment disposed more on the front end side than the assembly;
photographing the assembly by using the camera while turning on a second lighting equipment disposed more on the front end side than the assembly so as to be disposed at a different position from the first lighting equipment;
specifying a position of an outer peripheral surface of the insulator when viewing the assembly from the front end side in an axial direction, by using a first photographed image obtained in the photographing of the assembly while turning on the first lighting equipment;
specifying a position of an inner peripheral surface of the main metal fitting when viewing the assembly from the front end side in the axial direction, by using a second photographed image obtained in the photographing of the assembly while turning on the second lighting equipment; and
specifying a size of a clearance between the insulator and the main metal fitting by using the position of the outer peripheral surface of the insulator which is specified in the specifying of the position of the outer peripheral surface of the insulator and the position of the inner peripheral surface of the main metal fitting which is specified in the specifying of the position of the inner peripheral surface of the main metal fitting.

2. The method for manufacturing the spark plug according to claim 1, wherein a distance in a direction along the axis between the first lighting equipment and the assembly is longer than a distance in a direction along the axis between the second lighting equipment and the assembly.

3. The method for manufacturing the spark plug according to claim 1, wherein the first lighting equipment and the second lighting equipment include respective light emitting surfaces each having an annular shape when viewed from a rear end side in the axial direction, and
wherein an outer diameter of the light emitting surface of the second lighting equipment is larger than an outer diameter of the light emitting surface of the first lighting equipment.

4. The method for manufacturing the spark plug according to claim 1, wherein the light emitting surface of the second lighting equipment faces the assembly, and is a curved surface which becomes a curved line in a cross-section including the axis.

5. The method for manufacturing the spark plug according to claim 1, wherein, of the first lighting equipment and the second lighting equipment, only the second lighting equipment is provided with a diffusion member between a light source of the second lighting equipment and the assembly.

6. The method for manufacturing the spark plug according to claim 1, wherein, in the specifying of the position of the outer peripheral surface of the insulator, a plurality of first points indicating the position of the outer peripheral surface of the insulator are specified,
wherein, in the specifying of the position of the inner peripheral surface of the main metal fitting, a plurality of second points indicating the position of the inner peripheral surface of the main metal fitting are specified,
wherein, in the specifying of the size of the clearance, distances for all combinations of the first points located within a specific range in a circumferential direction and the second points located within the specific range are calculated, and
wherein a minimum value of the calculated distances for all the combinations is specified as a minimum value of the clearance in the specific range.

7. The method for manufacturing the spark plug according to claim 1, wherein when the size of the clearance is equal to or greater than a predetermined value, the assembly is determined as a non-detective product, and then the assembly determined as a non-detective product is transferred to a next process.
